(19) United States
(12) Patent Application Publication
(10) Pub. No.: US 2018/0277836 A1
(43) Pub. Date: Sep. 27, 2018

(54) ELECTRODE FOR HIGH-CURRENT-DENSITY OPERATION

(71) Applicant: Elchemtech Co., Ltd., Seoul (KR)

(72) Inventors: Sang Bong MOON, Seoul (KR); Yun Ki CHOI, Seoul (KR); Chang Hwan MOON, Seoul (KR); Hye Young JUNG, Incheon (KR); Nak Heon CHOI, Gyeonggi-do (KR); Jun Young LEE, Gyeonggi-do (KR); Kyoung Jun KIM, Gyeonggi-do (KR); Min Ju PARK, Seoul (KR); Hyun Hee KIM, Seoul (KR)

(73) Assignee: Elchemtech Co., Ltd., Seoul (KR)

(21) Appl. No.: 15/472,356

(22) Filed: Mar. 29, 2017

(30) Foreign Application Priority Data
Mar. 27, 2017 (KR) 10-2017-0038486

(51) Int. Cl. H01M 4/36; H01M 4/48

(52) U.S. Cl. CPC H01M 4/366; H01M 4/48

(57) ABSTRACT

Disclosed is an electrode for high-current-density operation. The electrode includes a substrate 202, a first layer 204 which is positioned to be in contact with the substrate and which includes TiOₓ and an electronically conductive oxide, a second layer 206 which is positioned to be in contact with the first layer and which includes TiOₓ and an oxide having oxidation durability to an electrolyte, and a third layer 208 which is positioned to be in contact with the second layer and the electrolyte and which includes TiOₓ and an oxide oxidizing the electrolyte.

### BACKGROUND OF THE INVENTION

### 1. Field of the Invention

The present invention relates to an electrode for high-current-density operation, and more particularly to an electrode for high-current-density operation applied to the electrolysis of brine and sulfuric acid.

### 2. Description of the Related Art

Electrochemical catalysts enable electron transfer at the interface between an electrode and an electrolyte, thereby causing a reaction. An anode having an electrochemical reaction catalyst may be applied to brine (or seawater) electrolysis, water electrolysis, electro-organic synthesis and electrochemical oxidation.

In a process of electrolyzing brine to produce chlorine and caustic soda, total energy consumption is proportional to the thermodynamic potential of an anode (the electrode at which oxidation occurs during electrolysis) and a cathode (the electrode at which reduction occurs during electrolysis), an electrode overvoltage, electrolytic solution resistance, and the total voltage of an electrolytic cell having membrane and bubble effects.

In order to reduce the energy consumption required to manufacture chlorine, an electrochemical catalyst for reducing the electrode overvoltage (charge transfer and reaction overvoltage), among the above-described elements, must be applied. Meanwhile, performance greatly depends on the type of material, surface morphology, and a process of manufacturing the catalyst.

Historically, prior to the 1980s, graphite was used as a common anode, but the graphite anode is consumed during operation and impurities are incorporated into the product. Accordingly, the common anode was converted to a dimensionally stable anode (DSA). The DSA has many advantages compared to the previously used graphite anode in terms of the low power consumption, a longer lifespan, stability of electrodes during electrolysis, and stable operation of electrolytic cells.

FIG. 1 is a conceptual diagram of an electrolytic device 100 for electrolyzing brine to produce chlorine. The electrolysis reaction of brine at an anode 102 is shown in FIG. 1 and is as follows. An oxidation reaction (a chlorine-generating reaction or an oxygen-generating reaction) occurs at the anode 102. When water (H₂O) and anions in brine move to the electrode due to an electric field, OH⁻ is decomposed into oxygen gas (O₂) and Cl⁻ is converted into chlorine gas (Cl₂) and electrons. The electrons move from the anode 102 to a cathode 104 along an external circuit (not shown). The electrochemical reactions occurring during movement of the electrons are shown in Reaction Formulas 1 and 2.

2OH⁻-->O₂+2H₂+2e [Reaction Formula 1]

2Cl⁻-->Cl₂+2e [Reaction Formula 2]

The anode 102 used in FIG. 1 generally includes a metal plate such as titanium, nickel, tantalum, or zirconium, or an expanded metal mesh plate of these metals, and is referred to as a substrate (or a mother substrate).

The electrochemical catalyst is generally oxides of a platinum group element or a mixture of the oxides, and is applied to the surface of the substrate. In the DSA, ruthenium oxide, iridium oxide, ruthenium-iridium mixed oxide, and platinum-iridium are mainly used as the coating material of the electrochemical catalyst. Ruthenium dioxide (RuO₂) is a catalyst for chlorine generation and has excellent catalytic activity. However, there is a significant drawback in that the long-term stability of the electrode coating is reduced due to the dissolution of the catalyst coating during electrolysis. In order to stabilize the RuO₂ component, for example, a mixture of RuO₂ and TiO₂ (titanium dioxide) is used. Since RuO₂ and TiO₂ have the same crystal structure, the mixture of RuO₂ and TiO₂ prevents chemical attack of the electrolyte and chlorine, which is a byproduct, and peeling of RuO₂. This effect is disclosed in U.S. Pat. Nos. 3,632,498 and 3,562,008.

Pyrolysis is the most common method for forming electrochemical catalysts. The performance of the catalyst manufactured by the pyrolysis method relates to the catalytic activity, and depends on cracks, pores, holes, and grain barriers between grains.

The durability of the electrochemical catalyst is based on an increase in resistance between the substrate and the electrochemical catalyst layer. The electrolyte penetrates the titanium substrate through defects in the electrochemical catalyst layer and chemically attacks the substrate to separate the active catalyst layer and to promote the growth of electrically insulative titanium oxides, resulting in increased resistance and inactivation of the anode (L. M. Da Silva, et al., J. Electroanal. Chem. 532, 141 (2002)).

On the other hand, in the related art, various methods have been used to suppress passivation of a substrate caused by contact with an electrolyte such as brine, sulfuric acid, or hydrochloric acid used for electrolysis.

The first method is to control a coating ratio (slope) of a predetermined electrochemical catalyst. For example, European Patent No. 0046449 A1 discloses a technique for increasing the number of coating/sintering cycles, thus increasing the thickness of a catalyst layer and extending the lifespan of the coating. In addition, DE 40 32 417 A1 discloses a RuO₂—TiO₂ coating technique having a coating ratio (slope) structure. In DE 40 32 417 A1, the ruthenium content in a layer is configured to decrease from 40 mol % to 20 mol % in a direction of the surface on which the electrolyte is present. European Patent No. 0867527 A1 discloses a technique for manufacturing an electrode of a three-component oxide mixture of TiO₂, RuO₂ and IrO₂, in which a ratio of metal oxides of noble metal to oxides of valve metal is increased from 13% to 100%. However, since the uppermost layer of the manufactured electrode includes only the oxides of noble metal, the long-term stability is expected to be reduced.

The second method is the application of different electrochemical catalyst layers. That is, in order to avoid the formation of a TiO₂ intermediate layer between the substrate and the electrochemical catalyst layer, an intermediate layer is interposed between the substrate and the electrochemical catalyst layer. The intermediate layer may be referred to as a lower layer, a barrier layer, or a protective layer. Korean Laid-Open Patent Application No. 2010-0085476 (Title of the invention: Complex noble metal oxide electrode for generating hypochlorous acid sterilizing water and method of manufacturing the same) discloses a structure including a protective layer and an electrochemical catalyst layer. However, there is a problem in that the durability of the electrode is not improved at a high current density.

High-current-density operation is required for practical use in the electrolysis of brine. High-current-density operation may lead to a compact device and a reduction in device costs. However, there is a problem in that voltage rises and durability is reduced under a high-current-density operation condition. From this point of view, the above-described patent applications have a drawback in that it is difficult to achieve high-current-density operation due to peeling of the electrode catalyst layer.

### SUMMARY OF THE INVENTION

Accordingly, the present invention has been made keeping in mind the above problems occurring in the related art, and an object of the present invention is to provide an electrode for high-current-density operation, which includes an electrochemical catalyst layer having an improved structure to ensure catalytic activity and long-term stability, thereby providing an anode capable of being operated at a high current density.

In order to accomplish the above object, the present invention provides an electrode for high-current-density operation. The electrode includes a substrate, a first layer which is positioned to be in contact with the substrate and which includes TiOₓ and an electronically conductive oxide, a second layer which is positioned to be in contact with the first layer and which includes TiOₓ and an oxide having oxidation durability to an electrolyte, and a third layer which is positioned to be in contact with the second layer and the electrolyte and which includes TiOₓ and an oxide oxidizing the electrolyte.

Further, according to the present invention, the oxide of the first layer includes any one of Nb, W, Ta, and Mo, a complex oxide thereof, or a complex metal thereof.

Further, according to the present invention, the first layer has a Nb—TiO₂ structure.

Further, according to the present invention, the oxide of the second layer includes any one of Ir and Sn, a complex oxide thereof, or a complex metal thereof.

Further, according to the present invention, the oxide of the third layer includes any one of IrO₂, RuO₂, SnO₂, and PdO₂, a complex oxide thereof, or a complex metal thereof.

In the present invention, the structure of an electrochemical catalyst layer is improved in order to increase the durability of an anode during electrolysis of brine, thereby enabling operation at a high current density.

Further, when an electrode for high-current-density operation of the present invention is applied to an electrochemical cell, a current density-voltage characteristic is improved, energy consumption during electrolysis is reduced, and a compact device can be designed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram of an electrolytic device for electrolyzing brine to produce chlorine;

FIG. 2 is a conceptual diagram of an electrode for high-current-density operation according to the present invention;

FIG. 3 is a picture (SEM) showing the surface of the electrode for high-current-density operation according to the present invention;

FIG. 4 is a process view showing the manufacture of the electrode for high-current-density operation according to the present invention;

FIG. 5 is a picture of an electrolytic cell for durability evaluation according to the present invention;

FIG. 6 is a picture of an electrolytic system for durability evaluation according to the present invention;

FIG. 7 is a graph showing the durability evaluation results of electrodes in Inventive Example 1, Inventive Example 2, Inventive Example 3, and Comparative Example 1 according to the present invention; and

FIG. 8 is a comparative graph showing the efficiencies of electrodes in Inventive Example 1, Inventive Example 2, Inventive Example 3, and Comparative Example 1 according to the present invention.

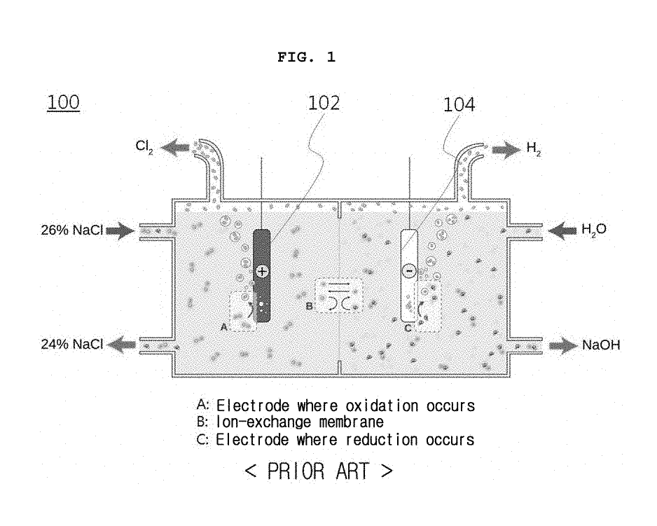

### DESCRIPTION OF THE PREFERRED EMBODIMENTS

Hereinafter, preferred embodiments of the present invention will be described in detail with reference to the appended drawings so as to enable a person having ordinary skill in the art to easily perform the present invention. However, descriptions of related known functions or constitutions regarding operation principles of the embodiments, even if they are pertinent to the preferred embodiments of the present invention, are considered unnecessary and may be omitted insofar as they would make the characteristics of the invention unclear.

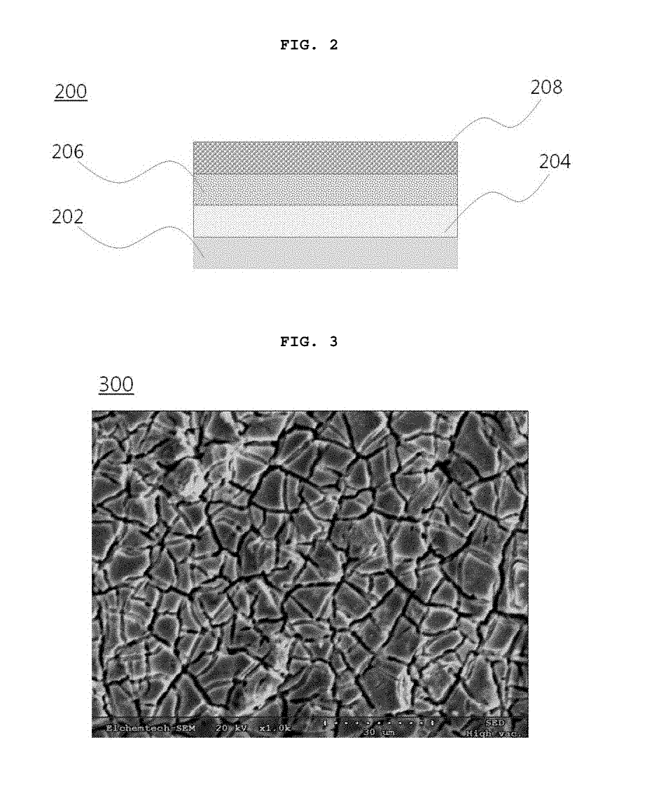

FIG. 2 is a conceptual diagram of an electrode for high-current-density operation 200 according to the present invention, and FIG. 3 is a picture (SEM) 300 showing the surface of the electrode for high-current-density operation according to the present invention. FIG. 3 is the result obtained from Inventive Example 1, as will be described later.

As shown in FIG. 2, a first layer 204 is positioned to be in contact with a substrate 202. This first layer 204 must be bondable to the substrate 202 and have excellent electrical and electronic conductivity. Accordingly, the first layer 204 may include a variety of valve metals such as titanium, tantalum, niobium, zirconium, hafnium, vanadium, molybdenum, and tungsten to impart bondability to the substrate 202. In the present embodiment, titanium is preferable. The component of the valve metal may be obtained from valve metal alkoxide with or without an acid in an alcohol solvent. In the present embodiment, any of the valve metals alkoxide, methoxide, ethoxide, isopropoxide, and butoxide may be included.

For example, titanium ethoxide, titanium propoxide, titanium butoxide, tantalum ethoxide, tantalum isopropoxide, or tantalum butoxide may be useful. However, the use of TiO₂ or Nb₂O₅ alone is not preferable in terms of poor electronic conductivity, and accordingly it is preferable to additionally provide a ceramic oxide having excellent electronic conductivity. Examples of suitable materials thereof include Nb, W, Ta, and Mo, and they are preferably used in the form of single or complex oxides or a composite metal. The best structure is Nb—TiO₂ having a conductivity of 0.2 Scm⁻¹, which is 10 times higher than the conductivity of 0.02 Scm⁻¹ of Ta—Nb₂O₅ or Ta—TiO₂. The best physical properties are ensured when the molar ratio of Nb to Ti is 3:7.

The substrate 202 is dipped into a first solution and then pyrolyzed to form the first layer 204. The thickness and the weight of the first layer 204 are proportional to each other, and the thickness of the first layer 204 is about 10 micrometers or less (at this thickness, the weight is 0.1 mg/cm² or less). The thickness of the first layer 204 is selected in consideration of an increase in manufacturing costs and the performance of the conductive layer.

As shown in FIG. 2, a second layer 206 is positioned between the first layer 204 and a third layer 208. Therefore, the second layer 206 must be bondable to the first layer 204 and the third layer 208, and must have excellent oxidation durability to an electrolyte and oxygen. Accordingly, the second layer 206 basically includes TiO₂ to provide bondability between the first layer 204 and the third layer 208.

The method of forming TiO₂ is the same as the method suggested in the first layer 204. As a catalyst phase added to TiO₂, preferably, a ceramic oxide having excellent oxygen generation potential and ability to withstand an oxygen generation reaction is provided. Examples of suitable materials thereof include Ir and Sn, and they may be used in the form of single or complex oxides or a composite metal. Ir, having the lowest oxygen overvoltage, is the most suitable material, and the best physical properties are ensured when the comparative molar ratio to TiO₂ is 5:5. A composition is manufactured using IrCl₃ and hydrochloric acid in an alcohol solution in combination with TiO₂ oxide. A metal salt is dissolved using n-butanol.

The electrode including the first layer 204 is dipped into a second solution and is then pyrolyzed to form the second layer 206. The thickness and the weight of the second layer 206 are proportional to each other, as in the first layer 204, and and the thickness of the second layer 206 is about 50 micrometers or less (at this thickness, the weight is 0.5 mg/cm² or less). The thickness of the second layer 206 is selected in consideration of an increase in manufacturing cost and an ability to generate oxygen.

As shown in FIG. 2, the third layer 208 is positioned to be in contact with the second layer 206 and the electrolyte. Therefore, the third layer 208 must be bondable to the the second layer 206, and must have excellent generation potential and ability to prevent chlorine generation. Accordingly, it is preferable that the third layer 208 basically include TiOₓ and further include an oxide capable of oxidizing the electrolyte in order to impart bondability to the second layer 206.

Further, in addition to TiOₓ, it is preferable to provide a ceramic oxide having excellent generation potential and durability against a chlorine-generating reaction as a chlorine-generating catalyst phase. Examples of suitable materials thereof include IrO₂, RuO₂, SnO₂, and PdO₂, and they may be used in a form of single or complex oxides or a composite metal. A composition is manufactured using RuCl₂, PdCl₂, IrCl₂, SnCl₄ and hydrochloric acid in an alcohol solution in combination with a TiO₂ oxide. As a metal salt, RuCl₂, PdCl₂, IrCl₂ and SnCl₄ are used, and they may be used in the forms of RuCl₃xH₂O, PdCl₂xH₂O, SnCl₄xH₂O, and IrCl₂xH₂O but will be hereinafter referred to as RuCl₂, PdCl₂, SnCl₄ and IrCl₂ for convenience. Generally, the metal salt is dissolved in alcohol such as isopropanol or butanol and is used together with hydrochloric acid, which is added in a small amount. In the present embodiment, it is preferable to use n-butanol.

The electrode including the second layer 206 is dipped into a solution containing an electrode catalyst having a desired composition, and is then pyrolyzed to manufacture the third layer 208. The surface of the electrode that is finally obtained is shown in FIG. 3. The thickness and the weight of the third layer 208 are proportional to each other, as in the first layer 204, and and the thickness of the third layer 208 is about 100 micrometers or less (at this thickness, the weight is 1 mg/cm² or less). The thickness of the third layer 208 is selected in consideration of an increase in manufacturing cost and an ability to generate oxygen.

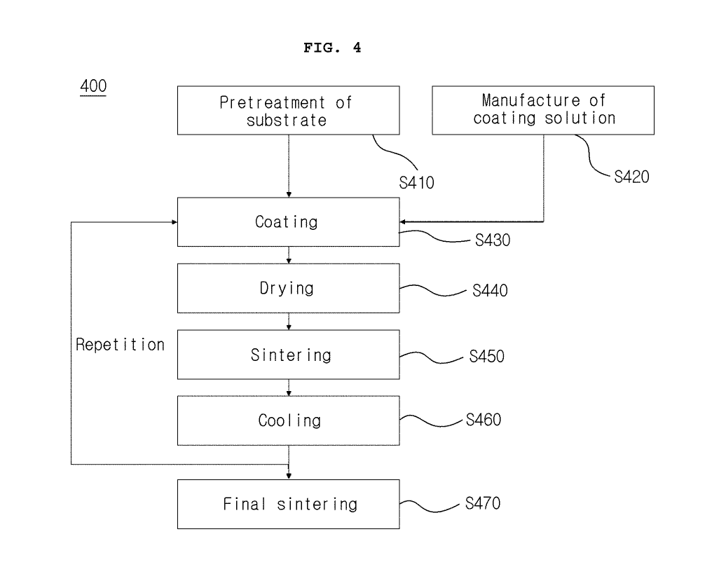

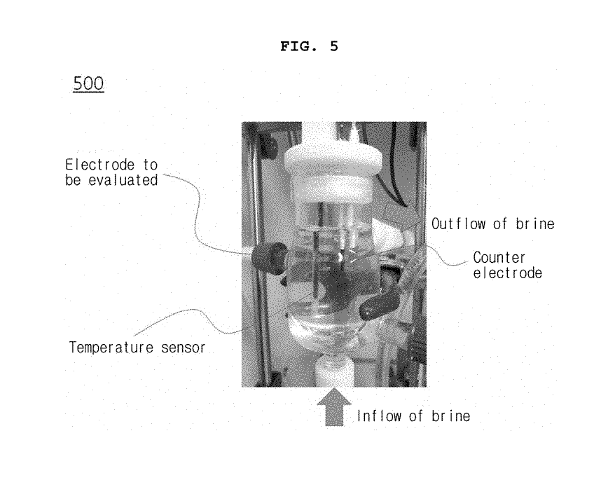

FIG. 4 is a process view 400 showing the manufacture of the electrode for high-current-density operation according to the present invention. The electrode shown in FIG. 2 is manufactured via the steps of FIG. 4. As shown in FIG. 4, the process for manufacturing the electrode includes seven steps in total. The first step is a step of pretreating the substrate, and each of the layers other than the substrate is subjected in common to the second to seventh steps.

First Step (S410): Pretreatment of Substrate

The surface of the substrate is roughened using sandpaper in order to provide the surface area required for the formation of the catalyst oxide. Chemical etching is then performed using oxalic acid (10 wt %) at 80° C. for 3 hours.

Second Step (S420): Manufacture of Coating Solution

Hydrochloric acid and the precursor of the electrochemical catalyst are added to a solvent such as alcohol (methanol, ethanol, or isopropyl alcohol) and mixed at a predetermined temperature for a predetermined time. The hydrochloric acid serves to maintain the binding force of the metal cations. The number of repetitions of the catalyst coating process depends on the ratio of alcohol, which is the solvent, to the amount of the precursor.

Third Step (S430): Coating

The pretreated substrate is coated with ink including the catalyst precursor. Examples of the coating method include dipping, painting, spraying, or spin coating, and the type of coating method depends on the condition of the ink including the catalyst precursor.

Fourth Step (S440): Drying

The entire material of the coated electrode is dried using air at 50 to 60° C. Drying is performed using a heat drying or far-infrared ray method.

Fifth Step (S450): Sintering

The dried electrode containing the electrode catalyst ink is sintered at 400 to 550° C., thus obtaining an oxide. Air is provided into a sintering furnace and baking is performed for 20 minutes. When the temperature is 550° C. or higher, the Ti substrate is partially oxidized and a TiOₓ layer is formed in an intermediate layer between the Ti substrate and a catalyst ink layer, thus increasing electrical resistance. Accordingly, it is preferable that the temperature be 550° C. or lower.

Sixth Step (S460): Cooling

After sintering, the baked electrode is cooled in air until the temperature thereof is the same as the ambient temperature.

Seventh Step (S470): Final Sintering

The coating, drying, sintering, and cooling processes of the third step (S430) to the sixth step (S460) are repeated until the desired thickness of the catalyst layer is obtained. During the final seventh step (S470), the electrode is heated at 500° C. for 1 hour and then slowly cooled to the ambient temperature. This seventh step relieves internal stress and homogenizes the catalyst phase. This step may or may not be performed depending on the solvent content.

### Inventive Example 1

1. Manufacture of Electrode

1-1. Pretreatment of Substrate

A titanium plate having a thickness of about 1 mm and a size of about 10×15 cm was polished using sandpaper and then chemically etched in a 10 wt % oxalic acid solution at 80° C. for 3 hours.

Conditions for the manufacture of the electrode, such as the type and ratio of the catalyst compounds, the number of coatings, and the sintering temperature (° C.), are described in the following Table 1.

TABLE 1

| | First layer | | | | Second layer | | | | Third layer | | | | |
|---|---|---|---|---|---|---|---|---|---|---|---|---|---|
| | | | Number | | | | Number | | | | | Number | |
| | | | of | Sintering | | | of | Sintering | | | | of | Sintering |
| | Ti | Nb | coatings | temperature | Ti | Ir | coatings | temperature | Ti | Ir | Ru | coatings | temperature |
| Inventive | 50 | 50 | 3 | 500 | 50 | 50 | 4 | 600 | 50 | 25 | 25 | 10 | 500 |
| Example 1 | | | | | | | | | | | | | |
| Inventive | 50 | 50 | 3 | 500 | 50 | 50 | 4 | 600 | | | | | |
| Example 2 | | | | | | | | | | | | | |
| Inventive | 50 | 50 | 3 | 500 | | | | | 50 | 25 | 25 | 10 | 500 |
| Example 3 | | | | | | | | | | | | | |
| Comparative | | | | | | | | | 50 | 25 | 25 | 10 | 500 |
| Example 1 | | | | | | | | | | | | | |

In Table 1, the metal is present in a chloride form, and titanium butoxide (Ti(OBu)₄) and niobium ethoxide (Nb(OC₂H₅)₅) are used for Ti and Nb.

1-2. Manufacture of First Layer

The coating composition of the first layer was manufactured on the basis of Inventive Example 1 described in Table 1. Titanium butoxide as a precursor material and niobium ethoxide were dissolved together with n-butanol in a 4.2 vol % HCl solution and stirred overnight. After all salt was dissolved, the titanium plate was dipped and then dried in air at 110° C. for 10 minutes. After drying, the electrode was sintered in an electric furnace in an ambient atmosphere at 500° C. for 10 minutes. After sintering, the electrode was cooled to room temperature. This procedure was repeated three times.

1-3. Manufacture of Second Layer

The coating composition of the second layer was manufactured on the basis of Inventive Example 1 described in Table 1. Titanium butoxide was used as a precursor material and IrCl₃, serving as a metal chloride, was dissolved together with n-butanol in a 4.2 vol % HCl solution and stirred overnight. After all salt was dissolved, the electrode including the first layer was dipped and then dried in air at 110° C. for 10 minutes. The dried electrode was sintered in an electric furnace in an ambient atmosphere at 600° C. for 10 minutes. After sintering, the electrode was cooled to room temperature. This procedure was repeated four times.

1-4. Manufacture of Third Layer

The coating composition of the third layer was manufactured on the basis of Inventive Example 1 described in Table 1. Titanium butoxide as a precursor material and RuCl₃ and IrCl₃, serving as metal chlorides, were dissolved together with n-butanol in a 4.2 vol % HCl solution and stirred overnight. After all salt was dissolved, the electrode including the second layer was dipped and then dried in air at 110° C. for 10 minutes. The electrode was sintered in an electric furnace in an ambient atmosphere at 500° C. for 10 minutes. After sintering, the electrode was cooled to room temperature. This procedure was repeated ten times.

2. Evaluation of Electrode

The lifespan and current efficiency of the manufactured electrode were measured.

2-1. Accelerated Life Test

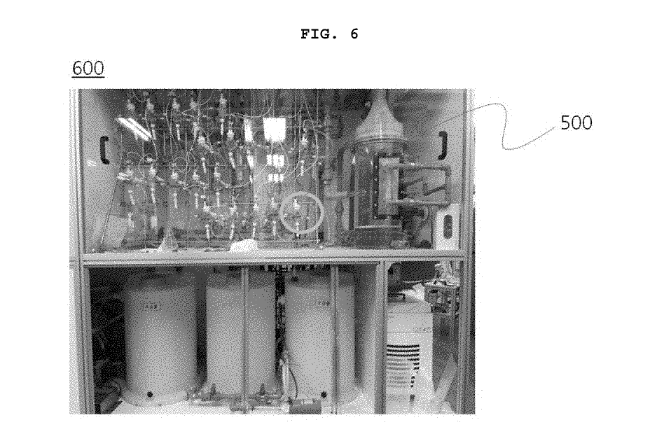

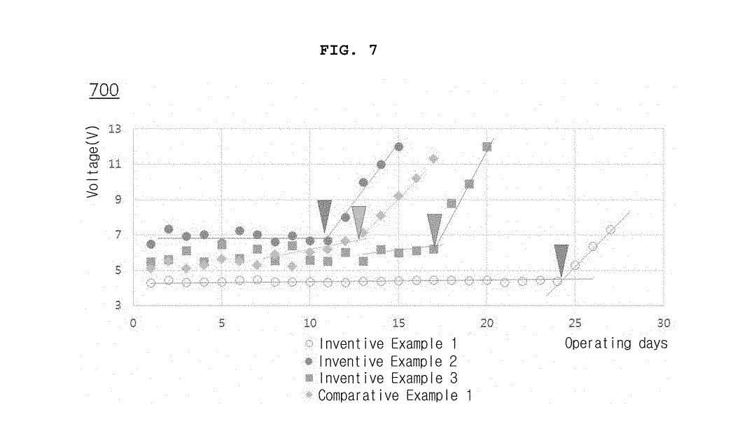

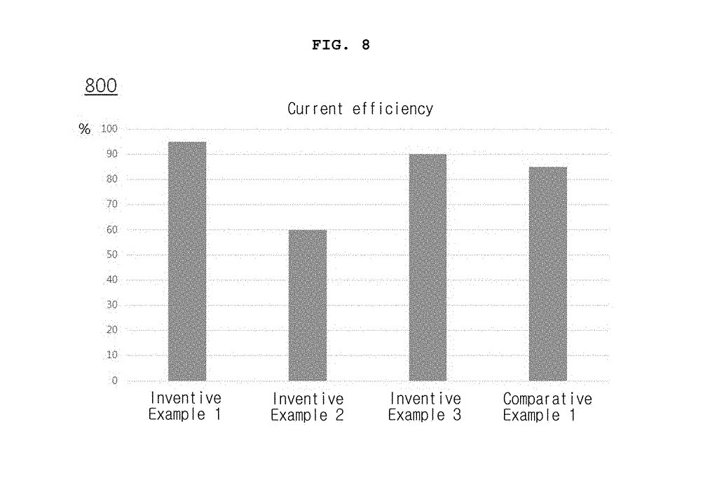

When conducted under an actual industrial operating condition of 3 A/cm², continuous testing provides reliable data on durability, but about five years is required in order to obtain sufficient data. Considering this fact, operation was performed at a high current density (20 A/cm²) in dilute brine (30 gL⁻¹) at 50° C. in an electrolytic cell 500 for the durability evaluation shown in FIG. 5 and an electrolytic system 600 for the durability evaluation shown in FIG. 6. The brine was circulated using a pump in order to maintain the uniform composition of the solution, and the pH of the solution was maintained at 6 to 7. Under this condition, it was confirmed that the electrode catalyst was corroded within several days. In order to evaluate the performance, the time required until the voltage was sharply increased was recorded. In the accelerated life test, it was found that the voltage was initially decreased slowly (due to activation of the inner surface of a porous anode), did not change over a long period of time, and finally increased sharply (see the voltage change characteristics of FIG. 7).

FIG. 5 is a picture of an electrolytic cell for durability evaluation according to the present invention, and FIG. 6 is a picture of an electrolytic system for durability evaluation according to the present invention.

2-2. Measurement of Current Efficiency

The manufactured electrode was operated at the same current density (3.5 kA/m², 80° C.) as the operating condition of an actual commercial process. The current efficiency was measured under this condition.

3. Measurement Result

FIG. 7 shows the lifespan (operating day) of the electrode in Inventive Example 1, and FIG. 8 shows the efficiency of the electrode in Inventive Example 1.

FIG. 7 is a graph 700 showing the durability evaluation results of the electrodes in Inventive Example 1, Inventive Example 2, Inventive Example 3, and Comparative Example 1 according to the present invention, and FIG. 8 is a comparative graph 800 showing the efficiencies of the electrodes in Inventive Example 1, Inventive Example 2, Inventive Example 3, and Comparative Example 1 according to the present invention.

### Inventive Example 2

1. Manufacture of Electrode

1-1. Pretreatment of substrate: Same as Inventive Example 1

1-2. Manufacture of first layer: Same as Inventive Example 1

1-3. Manufacture of second layer: Same as Inventive Example 1

1-4. Manufacture of third layer: Not manufactured, structure to suppress chlorine generation efficiency

2. Evaluation of Electrode

2-1. Accelerated life test: Same as Inventive Example 1

2-2. Measurement of current efficiency: Same as Inventive Example 1

3. Measurement Result

FIG. 7 shows the lifespan (operating day) of the electrode in Inventive Example 2, and FIG. 8 shows the efficiency of the electrode in Inventive Example 2.

### Inventive Example 3

1. Manufacture of Electrode

1-1. Pretreatment of substrate: Same as Inventive Example 1

1-2. Manufacture of first layer: Same as Inventive Example 1

1-3. Manufacture of second layer: Not manufactured

1-4. Manufacture of third layer: Same as Inventive Example 1

2. Evaluation of Electrode

2-1. Accelerated life test: Same as Inventive Example 1

2-2. Measurement of current efficiency: Same as Inventive Example 1

3. Measurement Result

FIG. 7 shows the lifespan (operating days) of the electrode in Inventive Example 3, and FIG. 8 shows the efficiency of the electrode in Inventive Example 3.

### Comparative Example 1

1. Manufacture of Electrode

1-1. Pretreatment of substrate: Same as Inventive Example 1

1-2. Manufacture of first layer: Not manufactured

1-3. Manufacture of second layer: Not manufactured

1-4. Manufacture of third layer: Same as Inventive Example 1

2. Evaluation of Electrode

2-1. Accelerated life test: Same as Inventive Example 1

2-2. Measurement of current efficiency: Same as Inventive Example 1

3. Measurement Result

FIG. 7 shows the lifespan (operating days) of the electrode in Comparative Example 1, and FIG. 8 shows the efficiency of the electrode in Comparative Example 1.

### Comparative Results of Inventive Examples 1, 2, and 3 and Comparative Example 1

The comparative results of Inventive Examples 1, 2, and 3 and Comparative Example 1 are described in the following Table 2.

TABLE 2

| | Performance | |
|---|---|---|
| | Efficiency | Durability (operating day) |
| Inventive Example 1 | 95% | 24 days |
| Inventive Example 2 | 60% | 13 days |
| Inventive Example 3 | 90% | 17 days |
| Comparative Example 1 | 84% | 11 days |

### CONCLUSION

The three-layer structure of Inventive Example 1 was the best in terms of current efficiency and durability, and was evaluated to be an electrode capable of being operated at a high current density.

In Inventive Example 2, efficiency was very low in view of the oxidation ability of chlorine ions, thus negatively affecting durability.

In Inventive Example 3, in the case of the catalyst having the chlorine oxidizing ability included in the layer protecting the substrate and having only electronic conductivity, it could be seen that the efficiency and the durability were improved but the catalyst was unsuitable for operation at a high current density.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An electrode for current-density operation, comprising:
a substrate,
a first layer which is positioned to be in contact with the substrate and which includes TiO₂ and an electronically conductive oxide,
a second layer which is positioned to be in contact with the first layer and which includes TiO₂ and an oxide having an oxidation durability to an electrolyte and oxygen, and
a third layer which is positioned to be in contact with the second layer and the electrolyte and which includes TiO₂ and an oxide oxidizing the electrolyte,
wherein the first layer has a Nb—TiO₂ structure, the molar ratio of Nb and Ti being 3:7, and
wherein the oxide of the second layer is comprised of Ir and the comparative molar ratio to TiO₂ is 5:5.

2.-4. (canceled)

5. The electrode of claim 1, wherein the oxide of the third layer includes any one of IrO₂, RuO₂, SnO₂, PdO₂, or a complex oxide thereof.

6. The electrode of claim 1, wherein the first layer has a thickness of 10 micrometers or less and a weight of 0.1 mg/cm² or less.

7. The electrode of claim 1, wherein the second layer has a thickness of 50 micrometers or less and a weight of 0.5 mg/cm² or less.

8. The electrode of claim 1, wherein the third layer has a thickness of 100 micro meters or less and a weight of 1 mg/cm² or less.
